(19) United States
(12) Patent Application Publication
(10) Pub. No.: US 2026/0231006 A1
(43) Pub. Date: Aug. 6, 2026

(54) NETWORK SEARCH DURING PRE-LANDING TIME WINDOW

(71) Applicant: QUALCOMM Incorporated, San Diego, CA (US)

(72) Inventors: Hewu GU, Shanghai (CN); Arvind Vardarajan SANTHANAM, San Diego, CA (US); Osama LOTFALLAH, San Diego, CA (US); Samir THAKKAR, San Diego, CA (US); Abhishek BHATNAGAR, San Diego, CA (US); Uttam PATTANAYAK, San Diego, CA (US); Tom CHIN, San Diego, CA (US); Ajith Tom PAYYAPPILLY, San Diego, CA (US); Jun DENG, Shanghai (CN); Sumalatha ARUGOLANU, Poway, CA (US); Balakrishna YANAMADALA, San Diego, CA (US); Andres ZACARIAS, San Diego, CA (US); Yiding ZHAO, Shenzhen (CN); Xiaochen CHEN, Beijing (CN); Nitin PANT, San Diego, CA (US); Zhongyue LOU, Beijing (CN); Subashini KRISHNAMURTHY, San Diego, CA (US); Xuqiang ZHANG, Beijing (CN)

(21) Appl. No.: 19/151,726

(22) PCT Filed: Mar. 31, 2023
(86) PCT No.: PCT/CN2023/085445

§ 371 Date: Jul. 29, 2025

(51) Int. Cl. H04W 48/16; H04W 48/18; H04W 52/02

(52) U.S. Cl. CPC H04W 48/16; H04W 48/18; H04W 52/0209

(57) ABSTRACT

Various aspects of the present disclosure generally relate to wireless communication. A user equipment (UE) may search for a network using a set of predicted mobile country codes (MCCs) during a flight. Some aspects more specifically relate to detecting an MCC in accordance with a set of predicted MCCs, where the set of predicted MCCs are used for the detection based at least in part on the detection occurring during the pre-landing time window. In some aspects, the detection of the MCC occurs during a pre-landing time window. For example, the UE may be in a low-power mode during the pre-landing time window and during detection of the MCC. In some aspects, the UE may determine the set of predicted MCCs, for example, according to a length of the flight and a source (such as a source airport or a source MCC).

### FIELD OF THE DISCLOSURE

Aspects of the present disclosure generally relate to wireless communication and specifically, to techniques and apparatuses for a network search during a pre-landing time window.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In certain situations, such as upon powering up, a user equipment (UE) may search for a network. For example, the UE may scan different frequencies or bands corresponding to radio access technologies (RATs) (e.g., 2G, 3G, 4G/LTE, 5G/NR, etc.), until a mobile country code and a public land mobile network (PLMN) are identified. The UE may then register with the network. In some examples, the UE may perform such a search upon exiting a low-power mode such as an airplane mode. For example, a user may trigger the UE to exit the low-power mode. As the number of RATs increases, the length of time used to search for a network may increase as well.

### SUMMARY

Some aspects described herein relate to a method of wireless communication performed at a user equipment (UE). The method may include identifying a pre-landing time window associated with the UE during a flight. The method may include detecting, during the pre-landing time window, a mobile country code (MCC) in accordance with a set of predicted MCCs, the set of predicted MCCs used for the detection in accordance with the detection occurring during the pre-landing time window. The method may include searching for a network associated with the MCC.

Some aspects described herein relate to a non-transitory computer-readable medium that stores a set of instructions for wireless communication by a UE. The set of instructions, when executed by one or more processors of the UE, may cause the UE to identify a pre-landing time window associated with the UE during a flight. The set of instructions, when executed by one or more processors of the UE, may cause the UE to detect, during the pre-landing time window, an MCC in accordance with a set of predicted MCCs, the set of predicted MCCs used for the detection in accordance with the detection occurring during the pre-landing time window. The set of instructions, when executed by one or more processors of the UE, may cause the UE to search for a network associated with the MCC.

Some aspects described herein relate to an apparatus for wireless communication. The apparatus may include means for identifying a pre-landing time window associated with the apparatus during a flight. The apparatus may include means for detecting, during the pre-landing time window, an MCC in accordance with a set of predicted MCCs, the set of predicted MCCs used for the detection in accordance with the detection occurring during the pre-landing time window. The apparatus may include means for searching for a network associated with the MCC.

Some aspects described herein relate to an apparatus for wireless communication at a UE. The UE may include at least one memory and at least one processor communicatively coupled with the at least one memory. The at least one processor may be operable to cause the UE to identify a pre-landing time window associated with the UE during a flight. The at least one processor may be operable to cause the UE to detect, during the pre-landing time window, an MCC in accordance with a set of predicted MCCs, the set of predicted MCCs used for the detection in accordance with the detection occurring during the pre-landing time window. The at least one processor may be operable to cause the UE to search for a network associated with the MCC.

Aspects generally include a method, apparatus, system, computer program product, non-transitory computer-readable medium, UE, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram illustrating an example of time windows of a flight by an aircraft, such as a passenger plane.

FIG. 4 is a diagram illustrating an example of network searching using a set of predicted mobile country codes (MCCs).

FIG. 5 is a diagram illustrating an example of detecting an MCC and scanning for a network.

FIG. 6 is a flowchart illustrating an example process performed, for example, by a UE that supports network search during a pre-landing time window.

FIG. 7 is a diagram of an example apparatus for wireless communication that supports network search in a pre-landing time window.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to searching for a network using a set of predicted mobile country codes (MCCs) during a flight. Some aspects more specifically relate to detecting an MCC in accordance with a set of predicted MCCs, where the set of predicted MCCs are used for the detection in accordance with the detection occurring during the pre-landing time window. In some aspects, the detection of the MCC occurs during a pre-landing time window. For example, a user equipment (UE) may be in a low-power mode during the pre-landing time window and during detection of the MCC. As another example, the pre-landing time window may occur entirely while the UE is in the low-power mode. In some aspects, the UE may determine the set of predicted MCCs, for example, according to a length of the flight and a source (such as a source airport or a source MCC). In some aspects, the UE may prioritize scanning of certain bands or frequencies, such as bands or frequencies corresponding to one or more predicted MCCs of the set of predicted MCCs. For example, the UE may prioritize scanning of certain bands or frequencies, corresponding to one or more predicted MCCs of the set of predicted MCCs, according to a location of the UE.

Particular aspects of the subject matter described in this disclosure can be implemented to realize one or more of the following potential advantages. In some examples, the described techniques can be used to reduce a length of time to select (or register with) a network after the UE exits a low-power mode (such as an airplane mode of the UE). By detecting an MCC in accordance with a set of predicted MCCs, the number of scanned bands may be reduced relative to indiscriminately scanning all bands, which may be different than the set of bands that a UE typically scans due to the destination of the flight having different cellular coverage than the source of the flight. By detecting the MCC or searching for the network in a low-power mode during the pre-landing time window, delay and user discomfort associated with registering with a network after exiting the low-power mode are reduced. In some aspects, the UE may determine the set of predicted MCCs, for example, according to a length of the flight and a source (such as a source airport or a source MCC), which increases the likelihood of quickly identifying an appropriate MCC relative to indiscriminately scanning all bands. By prioritizing scanning of bands or frequencies corresponding to one or more predicted MCCs according to a location of the UE, accuracy of prediction of the set of

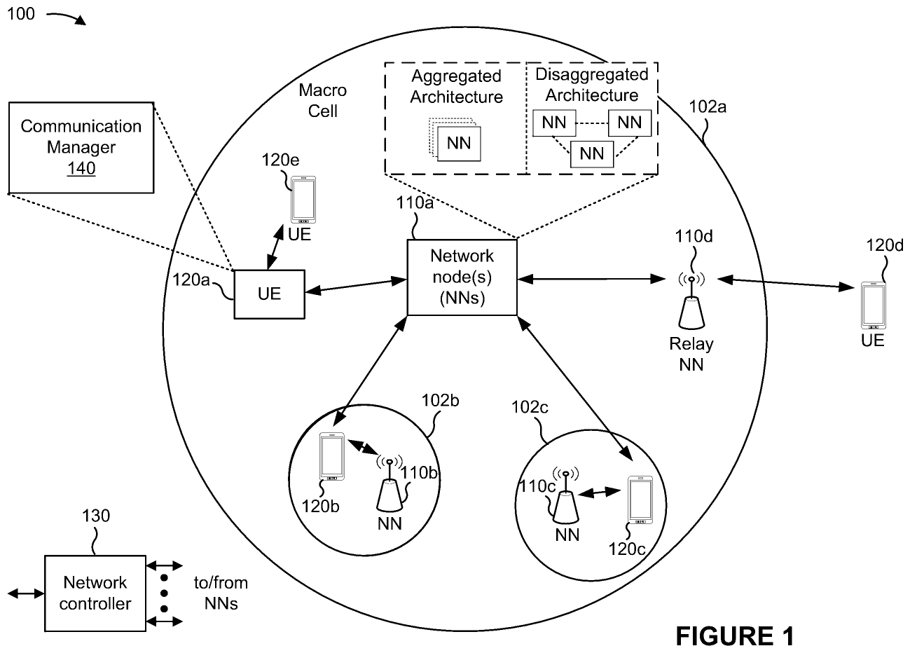

FIG. 1 is a diagram illustrating an example of a wireless network. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

In some aspects, the terms “base station” or “network node” may refer to an aggregated base station, a disaggregated base station, an integrated access and backhaul (IAB) node, a relay node, or one or more components thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses (for example, an augmented reality (AR), virtual reality (VR), mixed reality, or extended reality (XR) headset), a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium. Some UEs 120 (for example, UEs 102a and 120e) may communicate directly using one or more sidelink channels (for example, without a network node as an intermediary to communicate with one another).

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some examples, two or more UEs 120 (for example, shown as UE 120a and UE 120e) may communicate directly using one or more sidelink channels (for example, without using a network node 110 as an intermediary to communicate with one another). In other examples, the two or more UEs 120 may communicate through a vehicle-to-network-to-vehicle (V2N2V) protocol for example by communicating through a Uu interface using the LTE and/or NR uplink and downlink.

In some aspects, the UE 120 may include a communication manager 140. As described in more detail elsewhere herein, the communication manager 140 may identify a pre-landing time window associated with the UE during a flight; detect, during the pre-landing time window, a mobile country code (MCC) in accordance with a set of predicted MCCs, the set of predicted MCCs used for the detection in accordance with the detection occurring during the pre-landing time window; and search for a network associated with the MCC. Additionally, or alternatively, the communication manager 140 may perform one or more other operations described herein.

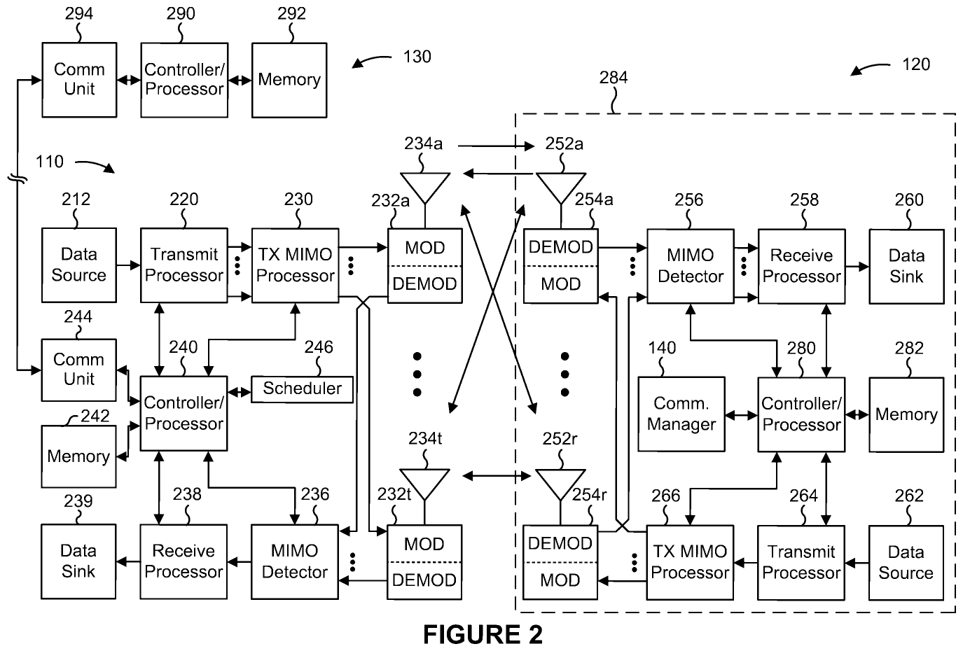

FIG. 2 is a diagram illustrating an example network node in communication with a UE in a wireless network. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

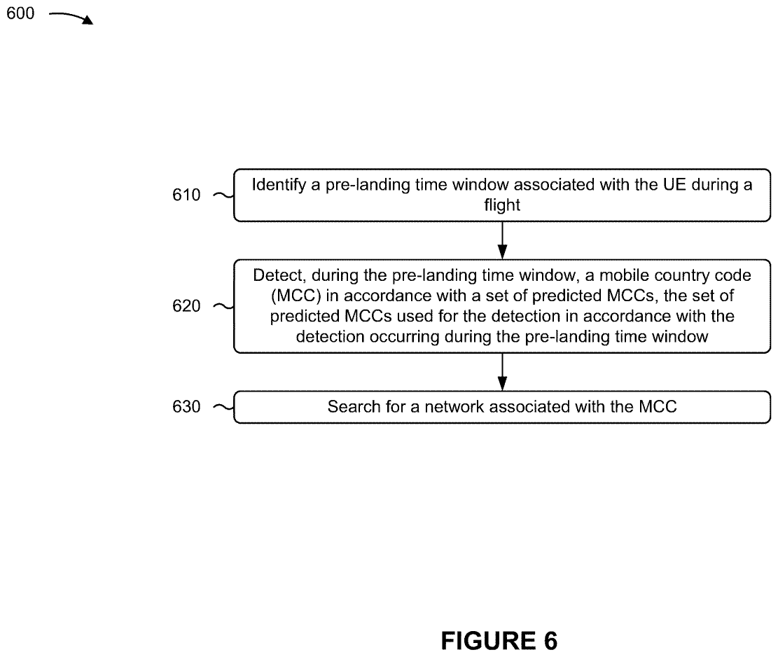

The controller/processor 240 of the network node 110, the controller/processor 280 of the UE 120, or any other component(s) of FIG. 2 may perform one or more techniques associated with searching for a network, as described in more detail elsewhere herein. For example, the controller/processor 240 of the network node 110, the controller/processor 280 of the UE 120, or any other component(s) of FIG. 2 may perform or direct operations of, for example, process 600 of FIG. 6, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, or other processes as described herein. In some examples, executing instructions may include running the instructions, converting the instructions, compiling the instructions, or interpreting the instructions, among other examples.

In some aspects, the UE 120 includes means for identifying a pre-landing time window associated with the UE 120 during a flight; means for detecting, during the pre-landing time window, an MCC in accordance with a set of predicted MCCs, the set of predicted MCCs used for the detection in accordance with the detection occurring during the pre-landing time window; and/or means for searching for a network associated with the MCC. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

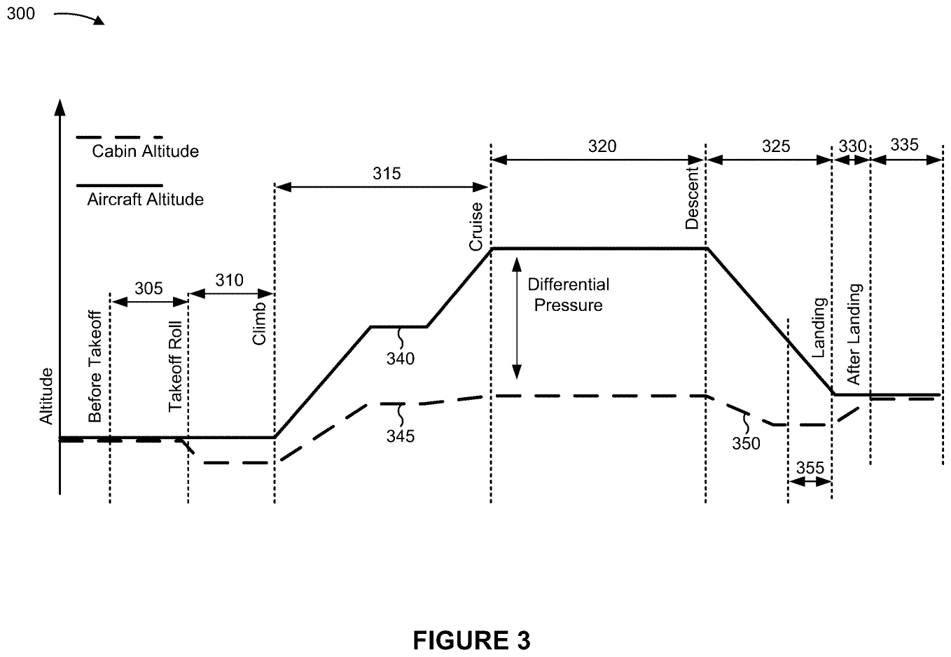

FIG. 3 is a diagram illustrating an example 300 of time windows of a flight by an aircraft such as a passenger plane. A flight may include a pre-takeoff time period 305, a takeoff roll time period 310, a climb time period 315, a cruise time period 320, a descent time period 325, a landing time period 330, and a post-landing time period 335. A line shown by reference number 340 indicates an actual altitude of the aircraft during the flight (e.g., relative to the ground, sea level, or another datum). A line shown by reference number 345 indicates a derived altitude value during the flight. The derived altitude value may correspond to an altitude value determined using a pressure sensor of a UE. For example, an atmospheric pressure can generally be used to derive an altitude value, since there is a relationship between atmospheric pressure and altitude. The derived altitude value may differ from the actual altitude when an atmospheric pressure in the aircraft differs from an atmospheric pressure outside the aircraft, which may be common during operation of the aircraft. Nonetheless, the derived altitude value can be used to determine a time period of the flight, such as according to changes in the derived altitude value. As just one example, the increase in atmospheric pressure in the aircraft at reference number 350 may indicate that the aircraft has entered the descent time period 325. A UE may identify an atmospheric pressure in the aircraft using a pressure sensor. For example, the UE may register with the pressure sensor and may determine a flight status (such as a current time period of the time periods 305 through 345).

While the UE is described above as determining the derived altitude value using a pressure sensor, the UE may additionally or alternatively determine the derived altitude value using another technique. For example, the UE may communicate with another device such as an access point or a UE (such as using sidelink or direct device-to-device communication) to obtain information regarding an altitude. The information regarding the altitude may be determined based on the aircraft's own altitude measurements, such as using radar, light detection and ranging, a navigation module of the aircraft, or the like. As another example, the information regarding the altitude may be based on a satellite signal used to track the flight's altitude. As yet another example, the UE may communicate with a satellite to determine the flight's altitude. In some aspects, the UE may determine the altitude using a selected technique of multiple different techniques. For example, the UE may attempt to determine the altitude using a first technique (which may be a least computationally expensive or resource-intensive technique). If the UE cannot determine the altitude using the first technique, the UE may switch to a second technique (which may be more computationally expensive or resource-intensive than the first technique) to determine the altitude.

As shown, the flight may include a pre-landing time window 355. For example, a UE may identify the pre-landing time window 355 according to the increase in atmospheric pressure in the aircraft at reference number 350. For example, upon determining that an atmospheric pressure has increased by a threshold amount following the cruise time period 320, the UE may identify the pre-landing time window 355. In some aspects, the pre-landing time window 355 may include a length of time in which the UE can search for a network (such as a length of time in which a signal strength at the UE, associated with the network, exceeds a threshold). For example, the pre-landing time window 355 may facilitate searching for a network prior to the UE exiting the low-power mode, as described elsewhere herein. As another example, the pre-landing time window 355 may include a length of time in which the aircraft is expected to be below a threshold altitude, such that the UE may successfully search for a network. In some examples, an entirety of the pre-landing time window may occur while the UE is in a low-power mode. For example, the pre-landing time window may occur while the UE is in low-power mode and when the UE senses that an end of the low-power mode is imminent.

The flight shown in example 300 may have a length, which may include, for example, time periods 305 through 335 or time periods 310 through 330, among other examples (such as other combinations of two or more of time periods 305 through 335). Some techniques described herein provide identification of a set of predicted MCCs (for example, according to a set of potential destination airports of a flight) using the length of the flight or other information.

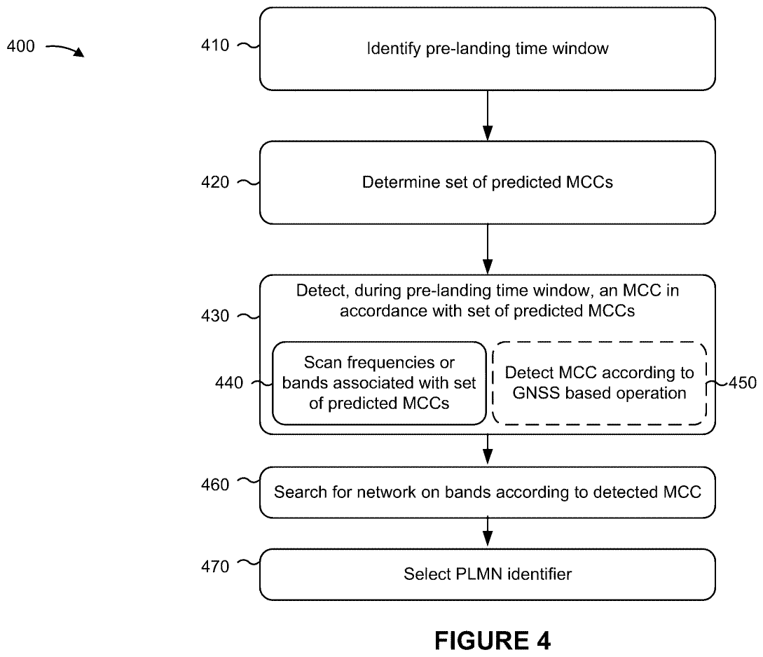

FIG. 4 is a diagram illustrating an example 400 of network searching using a set of predicted MCCs. The operations of example 400 may be performed by a UE, such as the UE 120. In some examples, the UE may start example 400 in a low-power mode such as an airplane mode. In some examples, the UE may perform the entirety of example 400 in the low-power mode. In the low-power mode, the UE may release or not establish a connection with a cellular network, and may cease searching for a network (until the pre-landing time window described below). For example, the UE may be in an idle mode while in the low-power mode. As another example, the UE may not be connected to or registered (e.g., camped) on a cell. Example 400 may occur at least partially during a flight. For example, the UE may start example 400 during the flight.

As shown by reference number 410, the UE may identify a pre-landing time window (such as the pre-landing time window 355 of FIG. 3). For example, the UE may identify the pre-landing time window using a pressure sensor of the UE. In some aspects, the pressure sensor may provide an indication of detected atmospheric pressure (as indicated by the line shown by reference number 350 of FIG. 3). The UE may identify the pre-landing time window using the indication of the detected atmospheric pressure. For example, the UE may determine that the detected atmospheric pressure has increased by a threshold amount (indicating a descent of a flight). Additionally, or alternatively, the UE may determine that the detected atmospheric pressure has increased by a threshold amount after a cruise time period (such as the cruise time period 320). The pre-landing time window may occur while the UE is in the low-power mode. For example, the pre-landing time window may end prior to the UE exiting the low-power mode.

As shown by reference number 420, the UE may determine a set of predicted MCCs. An MCC is a three-digit identifier that indicates a country or a region of a country, as provisioned by the International Telecommunication Union (ITU). The MCC may be used to identify bands or frequencies on which to search for a network (such as in connection with selection of a preferred PLMN). A PLMN may be associated with an MCC. For example, the MCC and a mobile network code (MNC) may identify an operator of the PLMN.

In some aspects, the UE may determine the set of predicted MCCs according to a length of time for which the UE has been in the low-power mode. For example, the UE may generally be in the low-power mode during the flight, so the length of time that the UE is in the low-power mode may provide an indication of the length of the flight. This may provide an indication of the length of the flight without utilizing a pressure sensor.

In some aspects, the UE may determine the set of predicted MCCs according to a length of the flight. For example, the UE may determine the length of the flight using sensor information from a pressure sensor of the UE, which may provide a more accurate indication of the length of the flight than using a length of time for which the UE has been in the low-power mode. In some aspects, the UE may determine the set of predicted MCCs according to an orientation of the flight, which the UE may determine using sensor information from a compass of the UE.

In some aspects, the UE may determine the set of predicted MCCs according to a source of the flight. For example, the UE may determine the set of predicted MCCs using a previous MCC on which the UE was registered. As another example, the UE may determine the set of predicted MCCs using a source airport of the flight. The UE may determine the source airport, for example, by connecting to a network associated with the airport, obtaining a location using a global navigation satellite system (GNSS) based operation, and mapping the location to a source airport (such as using information that maps locations to source airports).

In some aspects, the UE may determine the set of predicted MCCs by reference to a set of predicted destination airports. For example, the UE may use one or more of the previous MCC on which the UE was registered, the length of time for which the UE has been in the low-power mode, the orientation of the flight, the length of the flight, the sensor information, or the source airport of the flight to determine the set of predicted destination airports. In some aspects, the UE may determine the set of predicted MCCs using the length of the flight and the source airport according to a table, such as Table 1:

TABLE 1

| | |
|---|---|
| | Predicted MCCs for |
| Flight Length | Source: PVG |

| | | |
|---|---|---|
| 2 | hours | 440 450 466 460 |
| 3 | hours | 440 460 |
| 4 | hours | 520 460 |
| 5 | hours | 520 460 |
| 6 | hours | 460 |
| 7 | hours | 404 |
| 8 | hours | |
| 9 | hours | |
| 10 | hours | 302 |
| 11 | hours | 505 310 262 |
| 12 | hours | 310 262 |
| 13 | hours | 310 262 |
| 14 | hours | 310 302 262 |
| 15 | hours | 310 262 |

In Table 1, a flight departs from PVG airport. Given a flight length, the UE can identify a set of predicted MCCs corresponding to the source airport. For example, a flight length of 11 hours may correspond to a set of predicted MCCs including 505 (Australia), 310 (USA), and 262 (Germany).

In some aspects, the UE may identify or prioritize scanning of a set of predicted MCCs in accordance with a global navigation satellite system (GNSS) based operation. For example, the UE may identify a location using a GNSS module of the UE. The UE may use the location to prioritize scanning of one or more predicted MCCs of the set of predicted MCCs. For example, if the location is associated with one or more predicted MCCs (such as if the location indicates that the UE is within an area associated with the one or more predicted MCCs), the UE may prioritize scanning of the one or more predicted MCCs (meaning that the UE may scan bands or frequencies associated with the one or more predicted MCCs before bands or frequencies associated with a different predicted MCC). As another example, the UE may identify one or more MCCs that are to be excluded from a set of predicted MCCs due to a location determined using the GNSS based operation not being associated with the one or more MCCs. In some aspects, the UE may identify an MCC, for inclusion in the set of predicted MCCs, that is assigned to a country in which the location is located. As another example, the UE may identify a destination airport according to the location, and may identify an MCC corresponding to the destination airport (or a set of bands or frequencies corresponding to the destination), as described more detail elsewhere herein. In some aspects, the UE may perform the GNSS based operation according to a threshold number of satellites. For example, the UE may perform the GNSS based operation only if a threshold number of satellites (such as GNSS satellites) are available. This may allow for GNSS based determination of an MCC or refinement of an MCC prediction when GNSS positioning is likely to be accurate, and deactivation of GNSS based determination when GNSS positioning is unlikely to be accurate or available.

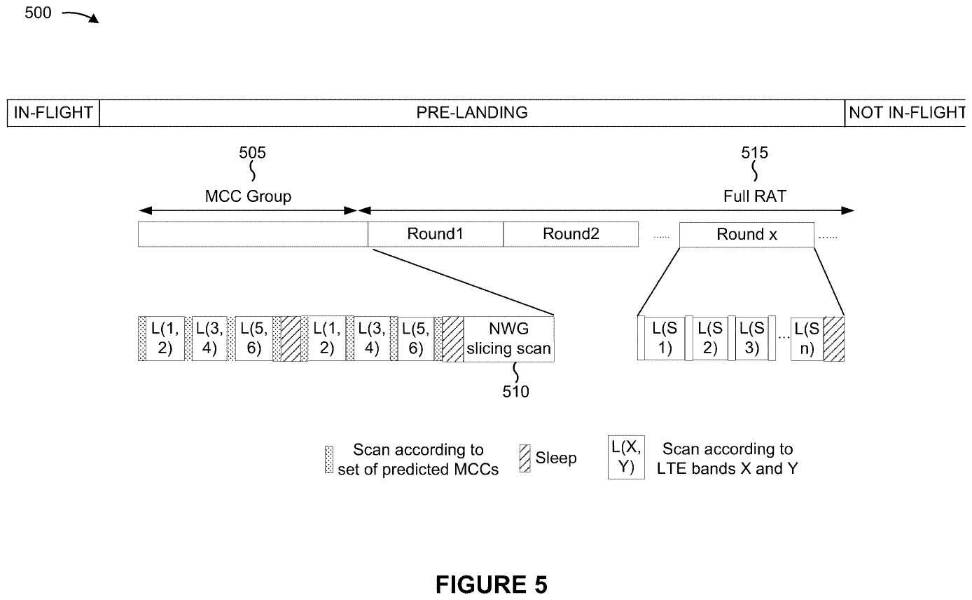

As shown by reference number 430, the UE may detect, during the pre-landing time window, an MCC in accordance with the set of predicted MCCs. For example, the UE may detect the MCC prior to deactivation of the low-power mode. Thus, the detection of the MCC may be referred to as early MCC detection. Detecting the MCC may include one or more of scanning on frequencies or bands associated with the set of predicted MCCs (shown by reference number 440) or detecting the MCC according to a GNSS based operation (shown by reference number 450). For example, the UE may scan on frequencies or bands associated with the set of predicted MCCs in parallel with detecting the MCC according to the GNSS based operation. As another example, the UE may prioritize scanning of frequencies or bands of one or more predicted MCCs in accordance with a location, determined by the GNSS based operation, indicating that the UE is at a location associated with the one or more predicted MCCs. Each of these operations is described in more detail below, and/or in connection with FIG. 5. In some aspects, the UE may enter a sleep state (such as a deep sleep) during the scanning, as described in connection with FIG. 5. In a sleep state, the UE may stop or not perform transmission and reception activities.

In some aspects, the UE may scan bands or frequencies (as shown by reference number 440) corresponding to a predicted MCC. For example, the UE may store information indicating a set of bands or frequencies corresponding to the predicted MCC. In some aspects, the UE may scan bands or frequencies corresponding to a destination airport (as identified according to a predicted MCC, a location, a length of a flight, or other information). The bands or frequencies may be identified by a list that indicates bands or frequencies per airport. For example, the list may indicate frequencies, per airport, for all supported RATs of the UE. The UE may receive information indicating the list, such as via a cloud interface. Thus, the list may facilitate identification of an MCC by enabling the UE to scan frequencies corresponding to predicted MCCs (which may, for example, correspond to predicted destination airports). In some aspects, if a previously registered MCC (such as an MCC on which the UE was registered before entering the low-power mode) is included in the set of predicted MCCs, the UE may prioritize frequencies belonging to bands of the previously registered MCC.

In some aspects, the UE may scan bands or frequencies according to a home PLMN (HPLMN) (such as an extended HPLMN (EHPLMN)) or a visited PLMN. For example, the UE may store information indicating frequencies or bands belonging to an HPLMN of the UE or for which registration succeeded on a visited PLMN. The UE may scan these frequencies or bands (such as by prioritizing these frequencies or bands during scanning). The UE may update the information when the UE registers on a network in a mobility scenario.

In some aspects, the UE may detect the MCC using a GNSS based operation (which may be the same GNSS based operation described with regard to reference number 420, or which may be a different GNSS based operation), as mentioned with regard to reference number 450. For example, the UE may attempt to obtain a location and derive an MCC from the location. In some aspects, the UE may attempt to obtain the location in parallel with scanning frequencies or bands of the set of predicted MCCs. Additionally, or alternatively, the UE may attempt to obtain the location after scanning frequencies or bands of the set of predicted MCCs (such as after scanning a first subset of the frequencies or bands). In some aspects, the UE may perform the GNSS based operation periodically (such as in connection with a periodicity).

As shown by reference number 460, in some aspects, the UE may search for a network on bands according to the detected MCC. For example, if the UE detects an MCC (which may belong to the set of predicted MCCs or may be a different MCC, and which may be detected by scanning frequencies or bands of the set of predicted MCCs or using a GNSS based operation), the UE may search for the network on bands according to the detected MCC. In some aspects, the UE may perform PLMN detection, and may collect PLMN identifiers on bands, supported by the UE, associated with the detected MCC. In some aspects, upon detecting an MCC, the UE may stop scanning bands on which no MCC was detected, and may continue scanning remaining bands (such as bands on which the MCC was detected or bands associated with the detected MCC). Thus, the UE may reduce a scope of the scanning, which conserves resources and reduces latency associated with the scan. In some aspects, the UE may search for the network during the pre-landing time window (such as while the UE is in the low-power mode). In some other aspects, the UE may search for the network after the pre-landing time window has ended (such as after the UE exits the low-power mode).

As shown by reference number 470, the UE may select a PLMN identifier. For example, the UE may select the PLMN identifier from PLMN identifiers identified during searching for a network (on a detected MCC, a set of predicted MCCs, or a full RAT scan). The UE may select the PLMN identifier using information stored by the UE, such as information indicating an HPLMN of the UE, forbidden PLMNs, equivalent HPLMNs, or the like. In some aspects, if the UE is in a home country of the UE, the UE may select an HPLMN (such as an EHPLMN) as the PLMN identifier. In some aspects, if the UE is not in a home country of the UE, the UE may select a PLMN in accordance with an operator PLMN (OPLMN). An OPLMN may indicate a priority for a PLMN identifier for the purpose of PLMN selection, and may be set by an operator of the UE (for example, the OPLMN may be configured in a subscriber identity module (SIM) of the UE). If a detected PLMN identifier matches an OPLMN, the UE (such as a non-access stratum entity of the UE) may select the detected PLMN identifier and may transmit a service request to register on a network having the detected PLMN identifier. If no detected PLMN identifier matches an OPLMN, the UE (such as a non-access stratum entity of the UE) may select the PLMN identifier from one or more detected PLMN identifiers, such as according to a quality metric of the detected PLMN identifiers. In some aspects, the UE may select the PLMN identifier during the pre-landing time window (such as while the UE is in the low-power mode). In some other aspects, the UE may select the PLMN identifier after the pre-landing time window has ended (such as after the UE exits the low-power mode).

FIG. 5 is a diagram illustrating an example 500 of detecting an MCC and scanning for a network. The operations of FIG. 5 may be performed by a UE, such as UE 120 or the UE of FIG. 3 or 4. FIG. 5 also shows time windows of a flight, including an in-flight time window, a pre-landing time window, and a “not in-flight” time window.

The scanning shown in example 500 may include LTE band scans (denoted by L(X,Y), where X and Y are bands supported by the UE) and scans according to a set of predicted MCCs. In other examples, the UE may scan a different RAT than LTE, such as 3G, 5G/NR, or the like. Scans according to the set of predicted MCCs are denoted by a dotted fill. A scan according to the set of predicted MCCs is described in connection with reference numbers 420, 430, and 440, above.

The UE may scan a first set of bands associated with the set of predicted MCCs during first time intervals (denoted by the dotted fill). For example, the UE may identify the first set of bands according to RATs supported by the UE, a mapping between the first set of bands and the set of predicted MCCs, an acquisition database of the UE, a mapping between the first set of bands and a destination airport of the UE, a combination thereof, or other information. As shown, the first time intervals may occur periodically within the pre-landing time window. The UE may scan a second set of bands, associated with LTE, during second time intervals (denoted by L(X,Y), as described above). For example, the UE may identify the second set of bands according to bands supported by the UE, an acquisition database of the UE, a combination thereof, or other information. As shown, the second time intervals may occur periodically within the pre-landing time window. In example 500, the first time intervals sometimes alternate, in time, with the second time intervals. The first time intervals and the second time intervals may occur within a time period referred to as an MCC group period, shown by reference number 505. In some aspects, the UE may scan the first set of bands or the second set of bands in accordance with a scanning order. The scanning order may indicate an order in which to scan bands. For example, if a first band is prioritized over a second band, the scanning order may indicate to scan the first band before the second band. In some aspects, the UE may prioritize a particular band in the scanning order. For example, the UE may prioritize the particular band if the particular band is shared between multiple predicted MCCs of the set of predicted MCCs.

As shown, the UE may scan different subsets of the second set of bands during different occurrences of the second time interval. For example, the UE may support LTE bands 1-6. In a first occurrence of the second time interval, the UE may scan LTE bands 1 and 2. In a second occurrence of the second time interval, the UE may scan LTE bands 3 and 4. In a third occurrence of the second time interval, the UE may scan LTE bands 5 and 6. Thus, the UE may alternate between scanning bands of the set of predicted MCCs, and LTE bands supported by the UE, which may increase the likelihood that an MCC and/or band is quickly identified, thereby decreasing power consumption and scanning time.

As shown by the diagonal hatch, in some examples, the UE may enter a sleep state such as a deep sleep. For example, the UE may enter the sleep state periodically. As another example, the UE may enter the sleep state between occasions of the first time interval. As another example, the UE may enter the sleep state between occasions of the second time interval. As another example, the UE may enter the sleep state between an occasion of the first time interval and an occasion of the second time interval. As another example, the UE may enter the sleep state after completing a scan of all RATs supported by the UE. Thus, power consumption of the UE is reduced.

As shown by reference number 510, in some aspects, the UE may scan a RAT other than a RAT associated with the second time interval. For example, the UE may scan an NR RAT (represented by “N”), a wideband code division multiple access (WCDMA) RAT (represented by “W”), a Global System for Mobile Communications (GSM) RAT (represented by “G”), or a combination thereof. The UE may scan these RATs after scanning the LTE RAT (or whichever RAT is scanned in the second time intervals) and any RATs associated with the set of predicted MCCs. This scan may be referred to as a “slicing scan” since this scan may prioritize certain bands and may occur prior to a full RAT scan. For example, the slicing scan may prioritize certain bands, such as a set of bands associated with a destination airport of the UE or a set of bands associated with a visited PLMN or HPLMN database of the UE (such as a set of bands belonging to an HPLMN or a set of bands associated with a successful registration on a visited PLMN).

As shown by reference number 515, in some aspects, the UE may perform a full RAT scan (e.g., one or more rounds of full RAT scan). For example, the UE may perform a full RAT scan if scanning according to the set of predicted MCCs is unsuccessful (for example, if the UE detects no MCC or if the UE can identify no predicted MCC), and may cease scanning of one or more bands associated with the set of predicted MCCs. The full RAT scan may include the UE scanning on all bands and RATs supported by the UE (such as without prioritizing scanning of the set of predicted MCCs).

In some aspects, the UE may detect an MCC as part of scanning during the first time interval or the second time interval. In such aspects, the UE may start a search on bands derived from the detected MCC, may collect available PLMNs on the bands, and may select a preferred PLMN identifier. If the UE does not detect an MCC as part of scanning during the first time interval or the second time interval (during the time period shown by reference number 505), then the UE may start a full RAT scan (as shown by reference number 515). If the UE detects an MCC during the full RAT scan, the UE may start a search on bands derived from the detected MCC, may collect available PLMNs on the bands, and may select a preferred PLMN identifier. If the UE does not detect an MCC during the full RAT scan, the UE may repeat the full RAT scan until an MCC is detected.

In some aspects, the UE may receive configuration information. The configuration information may indicate any one or more of a number of first time intervals, a periodicity of the first time intervals, a number of second time intervals, bands to scan during the second time intervals, a periodicity of the second time intervals, bands to scan during the slicing scan, an order in which to scan bands, a length of a sleep state, a placement of a sleep state, a number of recurrences of the full RAT scan, bands or RATs to scan during the full RAT scan, or the like.

FIG. 6 is a flowchart illustrating an example process 600 performed, for example, at or by a UE that supports network search during a pre-landing time window. Example process 600 is an example where the UE (for example, UE 120 or an apparatus of the UE) performs operations associated with a network search during a pre-landing time window.

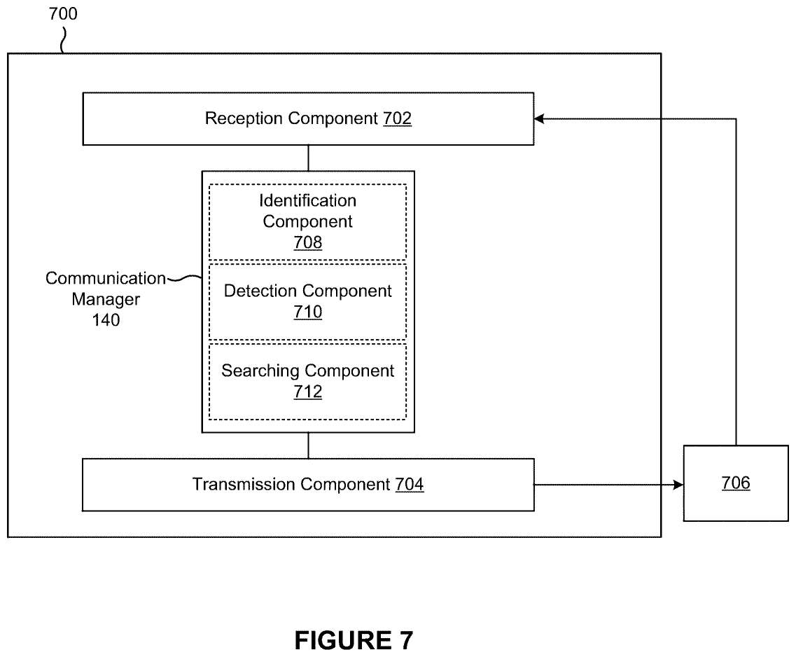

As shown in FIG. 6, in some aspects, process 600 may include identifying a pre-landing time window associated with the UE during a flight (block 610). For example, the UE (such as by using communication manager 140 or identification component 708, depicted in FIG. 7) may identify a pre-landing time window associated with the UE during a flight, as described above.

As further shown in FIG. 6, in some aspects, process 600 may include detecting, during the pre-landing time window, an MCC in accordance with a set of predicted MCCs, the set of predicted MCCs used for the detection in accordance with the detection occurring during the pre-landing time window (block 620). For example, the UE (such as by using communication manager 140 or detection component 710, depicted in FIG. 7) may detect, during the pre-landing time window, an MCC in accordance with a set of predicted MCCs, the set of predicted MCCs used for the detection in accordance with the detection occurring during the pre-landing time window, as described above.

As further shown in FIG. 6, in some aspects, process 600 may include searching for a network associated with the MCC (block 630). For example, the UE (such as by using communication manager 140 or searching component 712, depicted in FIG. 7) may search for a network associated with the MCC, as described above.

Process 600 may include additional aspects, such as any single aspect or any combination of aspects described below or in connection with one or more other processes described elsewhere herein.

In a first additional aspect, the UE is in a low-power mode, and identifying the pre-landing time window further comprises identifying the pre-landing time window prior to deactivation of the low-power mode, wherein an entirety of the pre-landing time window occurs prior to deactivation of the low-power mode.

In a second additional aspect, alone or in combination with the first aspect, process 600 includes determining the set of predicted MCCs in accordance with at least one of a length of time for which the UE has been in the low-power mode, an orientation of the flight, a length of the flight, or sensor information.

In a third additional aspect, alone or in combination with one or more of the first and second aspects, the set of predicted MCCs corresponds to a set of predicted destination airports derived from at least one of a previous MCC with which the UE was registered, the length of time, the orientation of the flight, the length of the flight, the sensor information, or a source airport of the flight.

In a fourth additional aspect, alone or in combination with one or more of the first through third aspects, detecting the MCC in accordance with the set of predicted MCCs further comprises scanning a plurality of bands associated with the set of predicted MCCs.

In a fifth additional aspect, alone or in combination with one or more of the first through fourth aspects, the plurality of bands is associated with a scanning order, wherein a particular band is prioritized in the scanning order if the particular band is shared between two or more MCCs of the set of predicted MCCs.

In a sixth additional aspect, alone or in combination with one or more of the first through fifth aspects, scanning the plurality of bands is in accordance with a scanning order for the plurality of bands or one or more frequencies associated with the plurality of bands.

In a seventh additional aspect, alone or in combination with one or more of the first through sixth aspects, process 600 includes scanning, after detecting the MCC, a set of bands associated with the MCC and ceasing scan of one or more bands associated with the set of predicted MCCs and not associated with the MCC.

In an eighth additional aspect, alone or in combination with one or more of the first through seventh aspects, detecting the MCC further comprises identifying a location using a GNSS based operation, and identifying the set of predicted MCCs according to a mapping between the location and the set of predicted MCCs.

In a ninth additional aspect, alone or in combination with one or more of the first through eighth aspects, detecting the MCC further comprises scanning a plurality of bands associated with the set of predicted MCCs.

In a tenth additional aspect, alone or in combination with one or more of the first through ninth aspects, detecting the MCC further comprises scanning a first set of bands, associated with the set of predicted MCCs, during a first time interval of the pre-landing time window, and scanning a second set of bands, associated with a full band scan, during a second time interval of the pre-landing time window.

In an eleventh additional aspect, alone or in combination with one or more of the first through tenth aspects, the first time interval occurs periodically within the pre-landing time window, and the second time interval occurs periodically within the pre-landing time window.

In a twelfth additional aspect, alone or in combination with one or more of the first through eleventh aspects, scanning the second set of bands further comprises scanning a first subset of the second set of bands during a first occurrence of the second time interval and a second subset of the second set of bands during a second occurrence of the second time interval.

In a thirteenth additional aspect, alone or in combination with one or more of the first through twelfth aspects, process 600 includes receiving signaling indicating the first subset or the second subset.

In a fourteenth additional aspect, alone or in combination with one or more of the first through thirteenth aspects, occurrences of the first time interval alternate with occurrences of the second time interval.

In a fifteenth additional aspect, alone or in combination with one or more of the first through fourteenth aspects, process 600 includes entering a sleep state between the first time interval and the second time interval, between two occurrences of the first time interval, or between two occurrences of the second time interval.

In a sixteenth additional aspect, alone or in combination with one or more of the first through fifteenth aspects, process 600 includes entering a sleep state between the first time interval and the second time interval, between two occurrences of the first time interval, or between two occurrences of the second time interval.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports network search in a pre-landing time window. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to and/or operable to perform one or more operations described herein in connection with FIGS. 3-5. Additionally or alternatively, the apparatus 700 may be configured to and/or operable to perform one or more processes described herein, such as process 600 of FIG. 6. In some aspects, the apparatus 700 may include one or more components of the UE described above in connection with FIG. 2.

The reception component 702 may receive communications, such as reference signals, control information, and/or data communications, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, a modem, a demodulator, a MIMO detector, a receive processor, a controller/processor, and/or a memory of the UE described above in connection with FIG. 2.

The transmission component 704 may transmit communications, such as reference signals, control information, and/or data communications, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, and/or a memory of the UE described above in connection with FIG. 2. In some aspects, the transmission component 704 may be co-located with the reception component 702 in a transceiver.

The communication manager 140 may identify a pre-landing time window associated with the UE during a flight. The communication manager 140 may detect, during the pre-landing time window, an MCC in accordance with a set of predicted MCCs, the set of predicted MCCs used for the detection in accordance with the detection occurring during the pre-landing time window. The communication manager 140 may search for a network associated with the MCC. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as an identification component 708, a detection component 710, and/or a searching component 712. Alternatively, the set of components may be separate and distinct from the communication manager 140. In some aspects, one or more components of the set of components may include or may be implemented within a controller/processor and/or a memory, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The identification component 708 may identify a pre-landing time window associated with the UE during a flight. The detection component 710 may detect, during the pre-landing time window, an MCC in accordance with a set of predicted MCCs, the set of predicted MCCs used for the detection in accordance with the detection occurring during the pre-landing time window. The searching component 712 may search for a network associated with the MCC.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed at a user equipment (UE), comprising: identifying a pre-landing time window associated with the UE during a flight; detecting, during the pre-landing time window, a mobile country code (MCC) in accordance with a set of predicted MCCs, the set of predicted MCCs used for the detection in accordance with the detection occurring during the pre-landing time window; and searching for a network associated with the MCC.
Aspect 2: The method of Aspect 1, wherein the UE is in a low-power mode and wherein identifying the pre-landing time window further comprises identifying the pre-landing time window prior to deactivation of the low-power mode, wherein an entirety of the pre-landing time window occurs prior to deactivation of the low-power mode.
Aspect 3: The method of any of Aspects 1-2, further comprising determining the set of predicted MCCs in accordance with at least one of: a length of time for which the UE has been in the low-power mode, an orientation of the flight, a length of the flight, or sensor information.
Aspect 4: The method of Aspect 3, wherein the set of predicted MCCs corresponds to a set of predicted destination airports for the flight derived from at least one of: a previous MCC with which the UE was registered, the length of time, the orientation of the flight, the length of the flight, the sensor information, or a source airport of the flight.
Aspect 5: The method of any of Aspects 1-4, wherein detecting the MCC in accordance with the set of predicted MCCs further comprises scanning a plurality of bands associated with the set of predicted MCCs.
Aspect 6: The method of Aspect 5, wherein the plurality of bands is associated with a scanning order, wherein a particular band is prioritized in the scanning order if the particular band is shared between two or more MCCs of the set of predicted MCCs.
Aspect 7: The method of Aspect 5, wherein scanning the plurality of bands is in accordance with a scanning order for the plurality of bands or one or more frequencies associated with the plurality of bands.
Aspect 8: The method of any of Aspects 1-7, further comprising scanning, after detecting the MCC, a set of bands associated with the MCC and ceasing scan of one or more bands associated with the set of predicted MCCs and not associated with the MCC.
Aspect 9: The method of any of Aspects 1-8, wherein detecting the MCC further comprises: identifying a location using a global navigation satellite system (GNSS) based operation; and prioritizing scanning of the set of predicted MCCs according to the location.
Aspect 10: The method of Aspect 9, wherein detecting the MCC further comprises scanning one or more bands associated with a particular predicted MCC of the set of predicted MCCs according to the location being associated with the particular predicted MCC.
Aspect 11: The method of any of Aspects 1-10, wherein detecting the MCC further comprises scanning a first set of bands, associated with the set of predicted MCCs, during a first time interval of the pre-landing time window; and scanning a second set of bands, associated with a full band scan, during a second time interval of the pre-landing time window.
Aspect 12: The method of Aspect 11, wherein the first time interval occurs periodically within the pre-landing time window, and the second time interval occurs periodically within the pre-landing time window.
Aspect 13: The method of Aspect 11, wherein scanning the second set of bands further comprises scanning a first subset of the second set of bands during a first occurrence of the second time interval and a second subset of the second set of bands during a second occurrence of the second time interval.
Aspect 14: The method of Aspect 13, further comprising receiving signaling indicating the first subset or the second subset.
Aspect 15: The method of Aspect 11, wherein occurrences of the first time interval alternate with occurrences of the second time interval.
Aspect 16: The method of Aspect 11, further comprising entering a sleep state between the first time interval and the second time interval, between two occurrences of the first time interval, or between two occurrences of the second time interval.
Aspect 17: An apparatus for wireless communication at a device, comprising a processor; memory coupled with the processor; and instructions stored in the memory and executable by the processor to cause the apparatus to perform the method of one or more of Aspects 1-16.
Aspect 18: A device for wireless communication, comprising a memory and one or more processors coupled to the memory, the one or more processors configured to perform the method of one or more of Aspects 1-16.
Aspect 19: An apparatus for wireless communication, comprising at least one means for performing the method of one or more of Aspects 1-16.
Aspect 20: A non-transitory computer-readable medium storing code for wireless communication, the code comprising instructions executable by a processor to perform the method of one or more of Aspects 1-16.
Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”).

1. An apparatus for wireless communication at a user equipment (UE), comprising:
at least one memory; and
at least one processor coupled with the at least one memory, the at least one processor operable to cause the UE to:
identify a pre-landing time window associated with the UE during a flight;
detect, during the pre-landing time window, a mobile country code (MCC) in accordance with a set of predicted MCCs, the set of predicted MCCs used for the detection in accordance with the detection occurring during the pre-landing time window; and
search for a network associated with the MCC.

2. The apparatus of claim 1, wherein the UE is in a low-power mode and wherein the at least one processor, to cause the UE to identify the pre-landing time window, is further operable to cause the UE to identify the pre-landing time window prior to deactivation of the low-power mode, wherein an entirety of the pre-landing time window occurs prior to deactivation of the low-power mode.

3. The apparatus of claim 1, wherein the at least one processor, to cause the UE to search for the network, is further operable to cause the UE to search for the network during the pre-landing time window.

4. The apparatus of claim 1, wherein the at least one processor is further operable to cause the UE to determine the set of predicted MCCs in accordance with at least one of:
a length of time for which the UE has been in a low-power mode,
an orientation of the flight,
a length of the flight, or
sensor information.

5. The apparatus of claim 4, wherein the set of predicted MCCs corresponds to a set of predicted destination airports for the flight derived from at least one of:
a previous MCC with which the UE was registered,
the length of time,
the orientation of the flight,
the length of the flight,
the sensor information, or
a source airport of the flight.

6. The apparatus of claim 1, wherein, to cause the UE to detect the MCC, the at least one processor is operable to cause the UE to:
identify a location using a global navigation satellite system (GNSS) based operation; and
prioritizing scanning of the set of predicted MCCs according to the location.

7. The apparatus of claim 6, wherein, to cause the UE to detect the MCC, the at least one processor is operable to cause the UE to scan one or more bands associated with a particular predicted MCC of the set of predicted MCCs according to the location being associated with the particular predicted MCC.

8. The apparatus of claim 1, wherein, to cause the UE to detect the MCC, the at least one processor is operable to cause the UE to scan a first set of bands, associated with the set of predicted MCCs, during a first time interval of the pre-landing time window; and
scan a second set of bands, associated with a full band scan, during a second time interval of the pre-landing time window.

9. The apparatus of claim 8, wherein the first time interval occurs periodically within the pre-landing time window, and the second time interval occurs periodically within the pre-landing time window.

10. The apparatus of claim 8, wherein, to cause the UE to scan the second set of bands, the at least one processor is operable to cause the UE to scan a first subset of the second set of bands during a first occurrence of the second time interval and a second subset of the second set of bands during a second occurrence of the second time interval.

11. The apparatus of claim 10, wherein the at least one processor is further operable to cause the UE to receive signaling indicating the first subset or the second subset.

12. The apparatus of claim 8, wherein occurrences of the first time interval alternate with occurrences of the second time interval.

13. The apparatus of claim 8, wherein the at least one processor is further operable to cause the UE to enter a sleep state between the first time interval and the second time interval, between two occurrences of the first time interval, or between two occurrences of the second time interval.

14. A method of wireless communication performed at a user equipment (UE), comprising:
identifying a pre-landing time window associated with the UE during a flight;
detecting, during the pre-landing time window, a mobile country code (MCC) in accordance with a set of predicted MCCs, the set of predicted MCCs used for the detection in accordance with the detection occurring during the pre-landing time window; and
searching for a network associated with the MCC.

15. The method of claim 14, wherein the UE is in a low-power mode and wherein identifying the pre-landing time window further comprises identifying the pre-landing time window prior to deactivation of the low-power mode, wherein an entirety of the pre-landing time window occurs prior to deactivation of the low-power mode.

16. The method of claim 14, wherein detecting the MCC in accordance with the set of predicted MCCs further comprises scanning a plurality of bands associated with the set of predicted MCCs.

17. The method of claim 16, wherein the plurality of bands is associated with a scanning order, wherein a particular band is prioritized in the scanning order if the particular band is shared between two or more MCCs of the set of predicted MCCs.

18. The method of claim 16, wherein scanning the plurality of bands is in accordance with a scanning order for the plurality of bands or one or more frequencies associated with the plurality of bands.

19. The method of claim 14, wherein detecting the MCC further comprises scanning a first set of bands, associated with the set of predicted MCCs, during a first time interval of the pre-landing time window; and
scanning a second set of bands, associated with a full band scan, during a second time interval of the pre-landing time window.

20. The method of claim 19, wherein the first time interval occurs periodically within the pre-landing time window, and the second time interval occurs periodically within the pre-landing time window.

21-30. (canceled)
